(19) United States
(12) Patent Application Publication
(10) Pub. No.: US 2012/0293489 A1
(43) Pub. Date: Nov. 22, 2012

(54) NONLINEAR DEPTH REMAPPING SYSTEM AND METHOD THEREOF

(75) Inventors: LIANG-GEE CHEN, Taipei (TW); CHIEN WU, Taipei (TW); CHUNG-TE LI, Taipei (TW); YEN-CHIEH LAI, Taipei (TW); CHAO-CHUNG CHENG, Taipei (TW); LING-HSIU HUANG, Taipei (TW)

(73) Assignees: HIMAX TECHNOLOGIES LIMITED, Tainan City (TW); NATIONAL TAIWAN UNIVERSITY, Taipei (TW)

(21) Appl. No.: 13/112,854

(22) Filed: May 20, 2011

(51) Int. Cl. G06T 15/00

(52) U.S. Cl. 345/419

(57) ABSTRACT

A nonlinear depth remapping method includes the following steps: firstly, an initial depth map associated with at least one image is received, with the image comprising a plurality of pixels and the initial depth map carrying an initial depth value of each pixel. Then, an exponential function is utilized to adjust the initial depth values, so as to generate an adjusted depth map.

### BACKGROUND OF THE INVENTION

1. Field of the Invention

The present invention generally relates to digital image processing, and more particularly to a nonlinear depth remapping system and method for a three-dimensional (3D) image pair.

2. Description of Related Art

When three-dimensional (3D) objects are mapped onto a two-dimensional (2D) image plane by prospective projection, such as an image taken by a still camera or a video camera, a lot of information, particularly 3D depth information, disappears. A 3D imaging system, however, can convey 3D information to a viewer by recording 3D visual information or by re-creating the illusion of depth. Although the 3D imaging technique has been known for over a century, the 3D display becomes more practical and popular owing to availability of high-resolution and low-price displays such as liquid crystal displays (LCDs).

FIG. 1 shows a block diagram of a conventional 3D imaging system 1 that captures a 2D image or a 3D image pair such as a left (L) image and a right (R) image from a target object by two cameras respectively. The depth generator 11 utilities stereo matching technique to acquire the left and right depth information from a stereo image pair. L image and R image, respectively. The left and right depth information is then processed by the depth-image-based rendering (DIBR) 13 to generate a left (L) image and a right (R) image, which should be viewed by the viewer, according to the matching relation of the L image and R image.

However, there are still some basic constraints in stereo videos, for example, there may be a discrepancy between the image which two-camera captured and the image that viewer saw. The visual percept of depth information felt by the two-camera and two-eye of viewer may be different as well. There could be some health issues occurring. People may feel dizzy after watching a long term 3D movie or someone has the problem to discriminate depth accurately. These phenomenons raise a new issue between depth information and human visual system.

In view of the foregoing, a need has arisen to propose a novel depth adjusting system and method for an image that could improve perceptual feeling and provide a much more comfortable viewing experience.

### SUMMARY OF THE INVENTION

In view of the foregoing, it is an object of the embodiment of the present invention to provide a nonlinear depth remapping system and method for an image which could remap or adjust 3D depth information to improve perceptual feeling and provide a much more comfortable viewing experience.

According to one embodiment, a nonlinear depth remapping system which comprises a depth generator and a depth adjusting unit is disclosed. The depth generator creates an initial depth map associated with at least one image, wherein the image comprises a plurality of pixels, and the initial depth map carries an initial depth value of each pixel. The depth adjusting unit utilizes an exponential function to adjust the initial depth values, so as to generate an adjusted depth map.

According to another embodiment, a nonlinear depth remapping method is disclosed. The method comprises the following steps: firstly, an initial depth map associated with at least one image is received, wherein the image comprises a plurality of pixels, and the initial depth map carries an initial depth value of each pixel. Then, an exponential function is utilized to adjust the initial depth values, so as to generate an adjusted depth map.

### BRIEF DESCRIPTION OF THE DRAWINGS

FIG. 1 shows block diagram of a conventional three-dimensional (3D) imaging system;

FIG. 2 shows a block diagram illustrating a nonlinear depth remapping system according to one embodiment of the present invention;

FIGS. 3A-3C exemplify an image and the corresponding initial depth map and adjusted depth map according to one embodiment of the present invention; and

FIG. 4 shows a flow diagram illustrating a nonlinear depth remapping method according to one embodiment of the present invention.

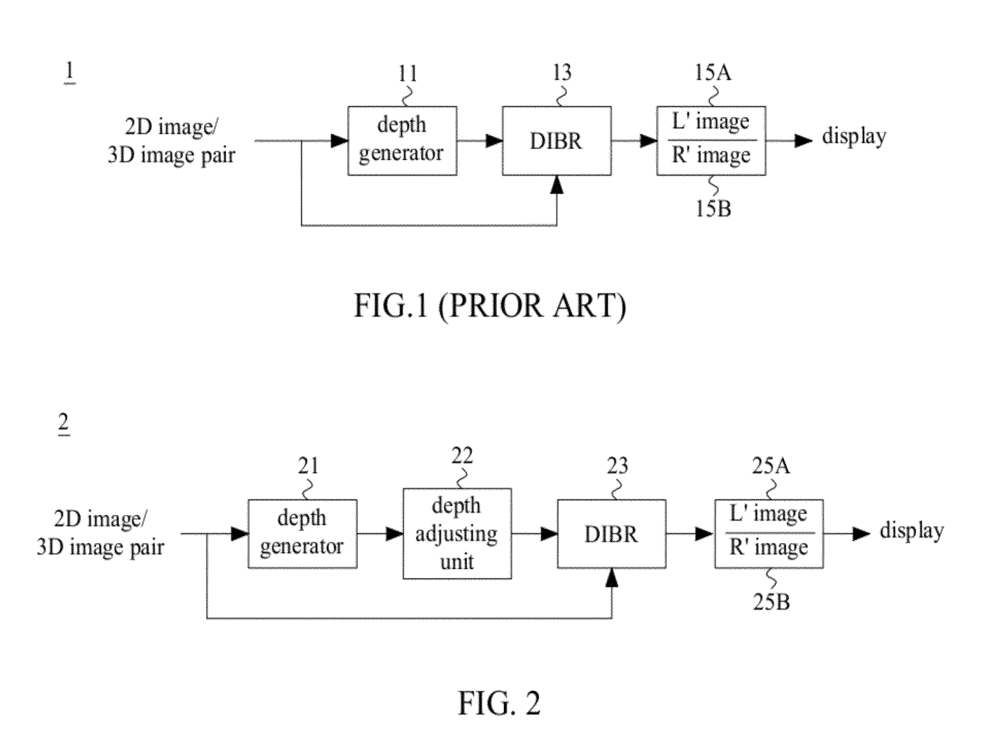

### DETAILED DESCRIPTION OF THE INVENTION

FIG. 2 shows a block diagram illustrating a nonlinear depth remapping system according to one embodiment of the present invention. The 3D image is also called a stereoscopic image. The system 2 comprises a depth generator 21, a depth adjusting unit 22 and a depth-image-based rendering (DIBR) unit 23. The depth generator 21 receives at least one image (e.g., a 2D image or a 3D image pair) to generate at least one depth map. For example, the depth generator 21 may receive the 3D image pair (e.g., a left (L) image and a right (R) image) to generate a left depth map and a right depth map that correspond to the original left image and the right image respectively. For another example, the depth generator 21 may receive the 2D image to generate a depth map.

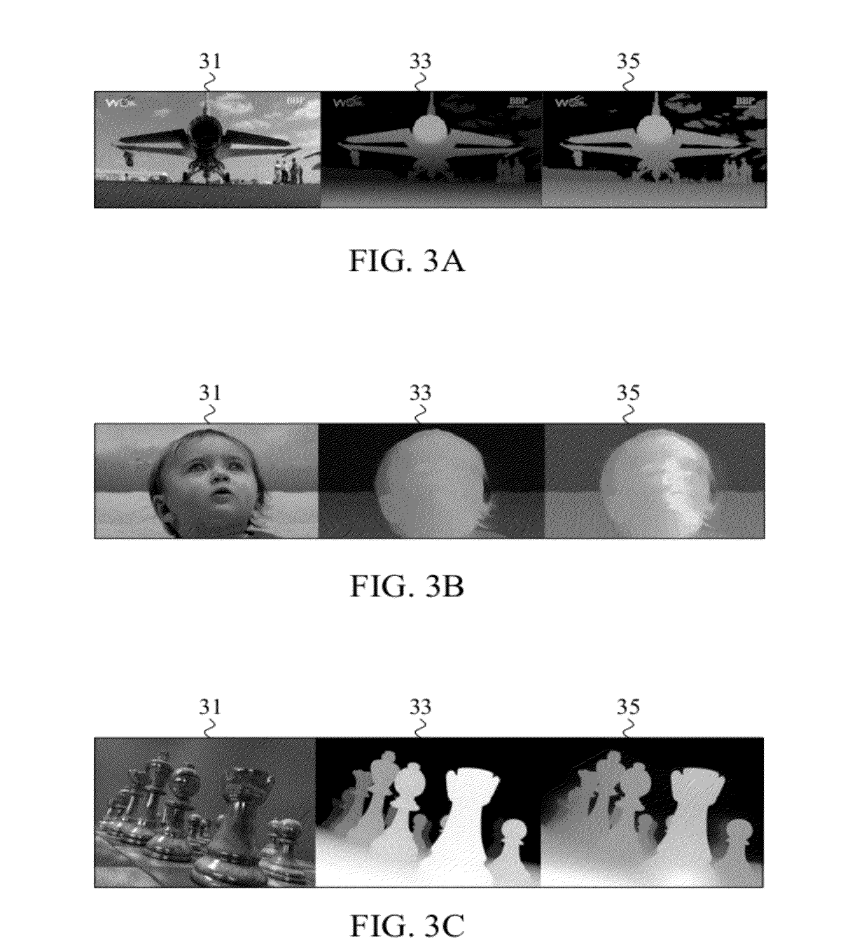

In order to facilitate explaining, take a single depth map for example as follows. Please refer to FIGS. 3A-3C as well. The depth generator 21 generates an initial depth map 33 associated with an image 31. The image 31 comprises a plurality of pixels, and in the initial depth map 33, each pixel or block has its corresponding depth value (initial depth value). For example, an object near a viewer has a greater depth value than an object far from the viewer. As a result, in a depth-map image, the object near the viewer is brighter than the object far from the viewer. Wherein, as shown in FIG. 3A (or FIGS. 3B, 3C), the depth information, in the initial depth map 33 may be suitable for human visual system.

After obtaining the initial depth values of the initial depth map 33, the depth adjusting unit 22 adjusts the initial depth values by an exponential function as the equations (1), (2),

$$\begin{matrix}O ( x , y ) = 255 \times {( \frac{D ( x , y )}{{D}_{m ax} - {D}_{m i n}} )}^{γ} . & ( 1 ) \\ γ = \frac{{D}_{avg} - D ( x , y )}{{D}_{avg}} . & ( 2 )\end{matrix}$$

Wherein D(x,y) is the initial depth value. Dₘₐₓ and Dₘᵢₙ are the maximum and minimum of the initial depth values, respectively. D_{avg} is average of Dₘₐₓ and Dₘᵢₙ. The exponent (γ) of the exponential function (equations (1)), which is not fixed, is calculated according to the difference between each initial depth value D(x,y) and the average depth value D_{avg}. Therefore, each initial depth value D(x,y) may be adjusted according to the difference between each initial depth value D(x,y) and the average depth value D_{avg}. Hence, the new depth values (adjusted depth values O(x,y)) are adjusted from the initial depth values D(x,y), so as to generate an adjusted depth map 35.

The adjusted depth map 35 from the depth adjusting unit 22 is fed to the depth-image-based rendering (DIBR) unit 23, which generates (or synthesizes) an adjusted left (L′) image 25A and an adjusted right (R′) image 25B for being displayed and viewed by viewer based on the adjusted depth map 35 and the original image. The DIBR unit 23 may be implemented by a suitable conventional technique, for example, disclosed in a disclosure entitled “A 3D-TV Approach. Using Depth-Image-Based Rendering (DIBR),” by Christoph Fehn, the disclosure of which is hereby incorporated, by reference. For another example, the DIBR further generates more than two images with different viewpoint for multi-view application.

It is noted that, after depth remapping processing as above, in the region of the displayed image that is far from the display plane such as LCD, the steps between disparities were enhanced. Whereas in the region of the displayed image that is near the display plane, the differences of disparities were compressed. Therefore, it increases disparity steps, both on the near and the far sides according to the proposed exponential function, so as to increase 3D feeling both on the foreground and the background objects. The nonlinear effect on stereo perception can be compensated.

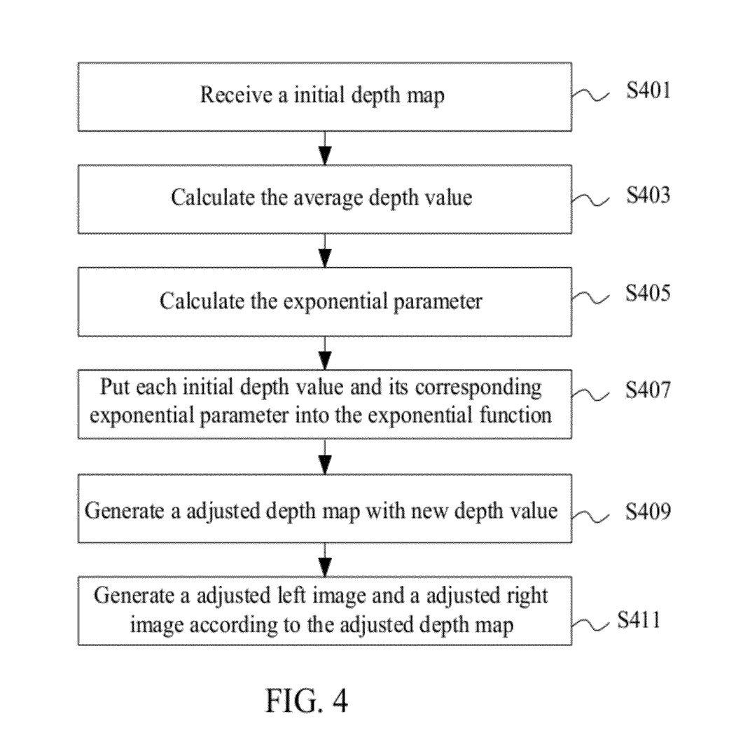

FIG. 4 shows a flow diagram illustrating a nonlinear depth remapping method according to one embodiment of the present invention. In step S401, the depth generator 21 receives an initial depth map 33. Subsequently, in step S403, the depth adjusting unit calculates the average depth value D_{avg} according to the maximum depth value Dₘₐₓ and the minimum depth value Dₘᵢₙ.

Afterward, in step S405, the depth adjusting unit 22 calculates the exponential parameter, the exponent (γ) of the exponential function, according to the difference between each initial depth value D(x,y) and the average depth value D_{avg} by equations (2). Then, in step S407, the depth adjusting unit 22 puts each initial depth value D(x,y) and its corresponding exponential parameter (γ) into the exponential function by equations (1) to remap the original depth values, so as to generate an adjusted depth map 35 with new depth value in step S409.

Finally, the DIBR unit 23 then generates an adjusted left (L′) image 25A and an adjusted right (R′) image 251B for being displayed and viewed by viewer based on the adjusted depth map 35 in step S411.

According to the foregoing embodiment, the present invention proposes a nonlinear depth remapping processing using an exponential function to adjust the depth information to be suitable for human visual system, which not only improves perceptual feeling, but also provides a much more comfortable viewing experience.

Although specific embodiments have been illustrated and described, it will be appreciated by those skilled in the art that various modifications may be made without departing from the scope of the present invention, which is intended to be limited solely by the appended claims.

What is claimed is:

1. A nonlinear depth remapping system, comprising:
a depth generator configured to generate an initial depth map associated with at least one image, wherein the at least one image comprises a plurality of pixels and the initial depth map carries an initial depth value of each pixel; and
a depth adjusting unit configured to utilize an exponential function to adjust the initial depth values so as to generate an adjusted depth map.

2. The system of claim 1, wherein each of the initial depth values is adjusted according to the difference between each of the initial depth values and an average depth value, and wherein the average depth value is average of the maximum and the minimum of the initial depth values.

3. The system of claim 2, wherein the exponential function has an exponent which is adjusted according to the difference between each of the initial depth values and the average depth value.

4. The system of claim 1, further comprising a depth-image-based rendering (DIBR) unit configured to receive the adjusted depth map and the at least one image to accordingly generate an adjusted left image and an adjusted right image.

5. A nonlinear depth remapping method, comprising:
receiving an initial depth map associated with at least one image, wherein the at least one image comprises a plurality of pixels and the initial depth map carries an initial depth value of each pixel; and
utilizing an exponential function to adjust the initial depth values, so as to generate an adjusted depth map.

6. The method of claim 5, wherein the step of utilizing the exponential function to adjust the initial depth values comprises:
calculating an average depth value as an average of the maximum and the minimum of the initial depth values; and
calculating an exponent of the exponential function, wherein the exponent is adjusted according to the difference between each of the initial depth values and the average depth value.

7. The method of claim 6, wherein:
the step of utilizing the exponential function to adjust the initial depth values further comprises putting each of the initial depth values and its corresponding exponent into the exponential function; and
each of the initial depth values is adjusted according to the difference between each of the initial depth values and an average depth value.

8. The method of claim 5, further comprising receiving the adjusted depth map and the at least one image to accordingly generate an adjusted left image and an adjusted right image.
